(19) United States
(12) Patent Application Publication
(10) Pub. No.: US 2014/0153723 A1
(43) Pub. Date: Jun. 5, 2014

(54) SYSTEM FOR PROVIDING PHYSICAL LAYER SECURITY

(71) Applicants: Georgia Tech Research Corporation, Atlanta, GA (US); Whisper Communications, LLC, Atlanta, GA (US)

(72) Inventors: Steven W. McLaughlin, Decatur, GA (US); Willie K. Harrison, Colorado Springs, CO (US); Jeffrey McConnell, Marietta, GA (US); Cenk Argon, Chapel Hill, NC (US)

(21) Appl. No.: 13/908,230

(22) Filed: Jun. 3, 2013

Related U.S. Application Data
(60) Provisional application No. 61/654,341, filed on Jun. 1, 2012.
(60) Provisional application No. 61/654,345, filed on Jun. 1, 2012.

(51) Int. Cl. H04W 12/02

(52) U.S. Cl. CPC H04W 12/02
USPC 380/270

(57) ABSTRACT

Systems, devices, and methods of physical layer security are disclosed. One such device includes a physical layer security module and a physical layer processing module. The physical layer security module is operable to transform user data in accordance with security characteristics. The physical layer processing module is operable to process the transformed data into a format suitable for the communication channel and further operable to transmit the processed data onto the communication channel. The security characteristics of the physical layer security module are such that decoding the intercepted user data by the eavesdropper results in a bit error rate of about one-half.

### CROSS REFERENCE TO RELATED APPLICATIONS

This application claims the benefit of U.S. Provisional Application No. 61/654,341, filed Jun. 1, 2012, and of U.S. Provisional Application No. 61/654,345, filed Jun. 1, 2012, each of which is hereby incorporated by reference herein.

### FIELD OF THE DISCLOSURE

The present disclosure relates to data communication, and more specifically, to secure communication at the physical layer.

### BACKGROUND

Conventional methods of providing secure communication over a channel use cryptography. Cryptography relies on the existence of codes that are “hard to break”: that is, one-way functions that are believed to be computationally infeasible to invert. Cryptography has become increasingly more vulnerable to an increase in computing power and to the development of more efficient attacks. Furthermore, the assumptions about the hardness of certain one-way functions have not been proven mathematically, so cryptography is vulnerable if these assumptions are incorrect.

Another weakness of cryptography is the lack of no precise metrics or absolute comparisons between various cryptographic algorithms, showing the tradeoff between reliability and security as a function of the block length of plaintext and ciphertext messages. Instead, a particular cryptographic algorithm is considered “secure” if it survives a defined set of attacks, or “insecure” if it does not.

Cryptography as applied to some media (e.g., wireless networks) also requires a trusted third party as well as complex protocols and system architectures. Therefore, a need exists for these and other problems to be addressed.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure.

FIG. 1 is a block diagram of a communication system that provides physical layer security, according to some embodiments described herein.

FIG. 2A-C are block diagrams depicting various ways in which the functionality of a secure physical layer can be placed in the data path from a transmitter to a receiver, according to some embodiments described herein.

FIG. 3 is a block diagram illustrating physical layer security and cryptography in the data path from transmitter 120T to receiver 120R, according to some embodiments described herein.

FIG. 4 is a data flow diagram showing one method of configuring a secure physical layer in a transmitter and in a corresponding receiver, according to some embodiments described herein.

FIG. 5 is a data flow diagram showing another method of configuring a secure physical layer in a transmitter and in a corresponding receiver, according to some embodiments described herein.

FIG. 6 is a data flow diagram showing further detail on the secure transmission step of FIG. 4 or FIG. 5, according to some embodiments described herein.

FIG. 7 is a data flow diagram showing yet another method of configuring a secure physical layer in a transmitter and in a corresponding receiver, according to some embodiments described herein.

FIG. 8 is a hardware block diagram of a communication device from FIG. 1, according to some embodiments described herein.

### DETAILED DESCRIPTION

Disclosed herein are inventive techniques for securing user data against eavesdropping at the physical layer of a communication system. A transmitter provides security at the physical layer (referred to herein as “physical layer security”) by transforming user data in a manner that produces a bit error rate of about one-half at an eavesdropper receiving the secure bit stream. The transform used by a secure physical layer exploits characteristics of the communication channel in a manner that prevents unintended receivers (referred to herein as “eavesdroppers”) from obtaining partial or complete information about the transmitted user data. Security is guaranteed because a one-half bit error rate means a bit decoded by the eavesdropper is as likely to be incorrect as correct. A “friendly” or “intended” receiver recovers the transmitted user data by reversing the specific transformation process used in the transmitter. Notably, some embodiments of the secure physical layer disclosed herein are keyless, where conventional security mechanisms at a higher layer typically use keys.

The embodiments disclosed herein can be used with secure error correction codes, which are known to a person of ordinary skill in the art to provide physical layer security. One non-limiting example of a secure error correction code is a punctured error correction code. Another non-limiting example of a secure error correction code is a low density parity check (LDPC) codes. One class of LPDC codes is disclosed in “Secure Communication Using Error Correction Codes”, U.S. 20100275093, which is hereby incorporated herein by reference. Another non-limiting example of a secure error correction code is a non-systematic error correction code. One class of non-systematic error correcting codes is disclosed in “Secure Communication Using Non-Systematic Error Control Codes”, U.S. 20110246854, which is hereby incorporated herein by reference.

The embodiments disclosed herein can be also be used with any physical layer pre-processing that provides physical layer security. One example of a physical layer security pre-processor is an arrangement of rate-1 non-recursive convolutional encoders in series with permuters as disclosed in co-pending application “System for Providing Physical Layer Security”, U.S. Ser. No. 13/908,000, filed concurrently with this application.

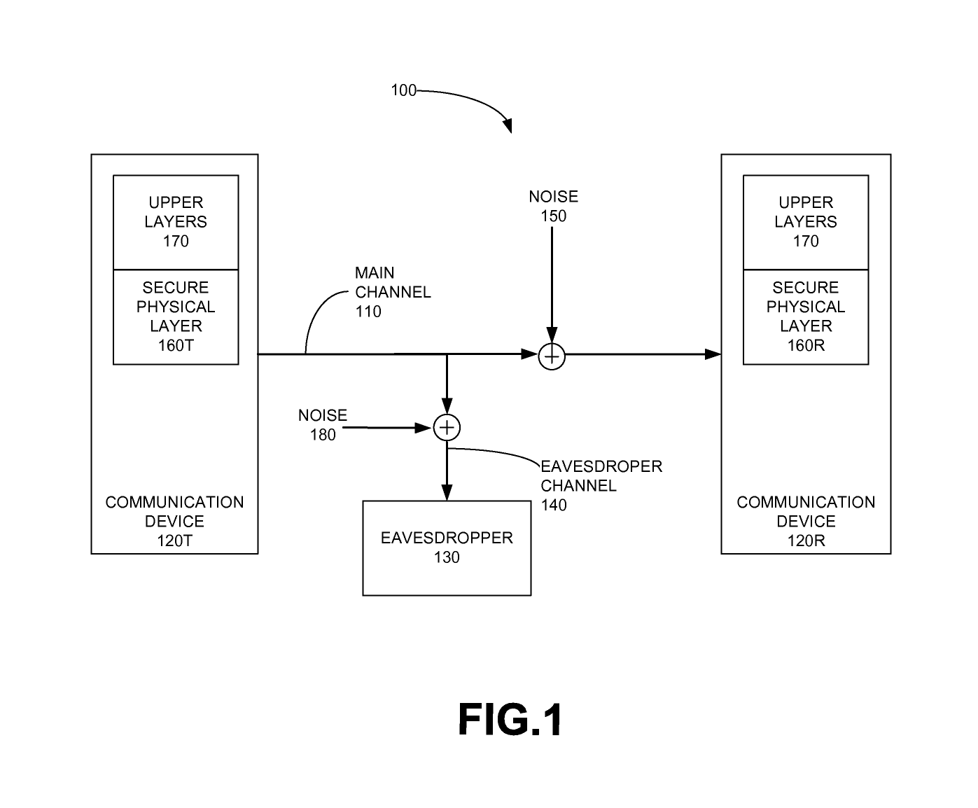

FIG. 1 is a system diagram of a transmitter device and a receiver device cooperating to provide physical layer security. Communication system 100 includes two parties that communicate over a main channel 110: communication device 120T, operating as a transmitter; and 120R, operating as a receiver. Although transmit and receive operations are discussed separately herein, a person of ordinary skill in the art would understand that some embodiments of device 120 have both transmitter and receiver functionality.

System 100 accounts for another device 130 (an “eavesdropper”) which may listen to (eavesdrop on) transmissions on main channel 110, over an eavesdropper channel 140. Eavesdropper 130 is passive with respect to main channel 110, i.e., eavesdropper 130 does not jam main channel 110, insert bits on main channel 110, etc. In some embodiments, main channel 110 and eavesdropper channel 140 are wireless. In one of these embodiments, transmitter 120T and receiver 120R are implemented using radio frequency identification (RFID) tags. In other embodiments, main channel 110 and eavesdropper channel 140 are wired (wireline) channels.

Main channel 110 is subject to a noise input 150. As a result, communication from transmitter 120T to receiver 120R over main channel 110 is not error-free. The performance of main channel 110 can be described in terms of a bit error rate (BER) at receiver 120R, which can also be understood as a probability of error (p_{M}) at receiver 120R. Considering a single bit, the probability of receiver 120R seeing a 1 when transmitter 120T actually sent a 0, or seeing a 0 when transmitter 120T actually sent a 1, is p_{MAIN}. Conversely, the probability of receiver 120R seeing a 1 when transmitter 120T actually sent a 1, or seeing a 0 when transmitter 120T actually sent a 0, is 1-p_{MAIN}.

A secure physical layer 160 residing in transmitter 120T conveys information across main channel 110, where it is recovered by a secure physical layer 160 residing in receiver 120R. Though not discussed in detail herein, communication device 120 may implement other layers above secure physical layer 160, for example a Media Access Control (MAC) layer, a network layer, a transport layer, a session layer, etc. Such layers are depicted in FIG. 1 as upper layers 170.

As a physical layer, secure physical layer 160 uses techniques known to a person of skill in the art, such as bit mapping, modulation, line coding, etc., to process data into a format that is suitable for the physical characteristics of main channel 110, and to transmit the processed data on main channel 110. Secure physical layer 160 may also use techniques such as channel coding and/or error correction to convey information in a manner which takes into account noise input 150, thus reducing p_{MAIN} as compared to performance without such techniques.

As noted earlier, eavesdropper 130 uses eavesdropper channel 140 to intercept communications between transmitter 120T and receiver 120R. Eavesdropper 130 then decodes intercepted data in an attempt to recover user data conveyed from transmitter 120T and receiver 120R. However, eavesdropper channel 140 is subject to a noise input 180 with characteristics different from noise input 150. The probability of error at eavesdropper 130 is referred to herein as p_{EVE}. Security is achieved by secure physical layer 160 whenever p_{EVE} is about one-half, since in this scenario it is just as likely that decoding a bit received by eavesdropper 130 produces an incorrect value as it is that the decode produces the correct value. As used herein, the term “about” can include traditional rounding according to significant figures of numerical values.

Secure physical layer 160 in transmitter 120T achieves the one-half value for p_{EVE} by transforming user data to exploit characteristics that are specific to main channel 110. For example, a secure physical layer 160 may exploit one set of characteristics for a wired or wireline channel and another set for a wireless channel. As another example, a secure physical layer 160 may exploit one set of characteristics for a near-field wireless channel, another set for a short-range wireless channel such as WiFi, and yet another set for a long-range wireless channel such as WiMAX. Secure physical layer 160 in receiver 120R recovers the originally transmitted user data from the received transformed data by performing the inverse or complement of the particular transform used by transmitter 120T.

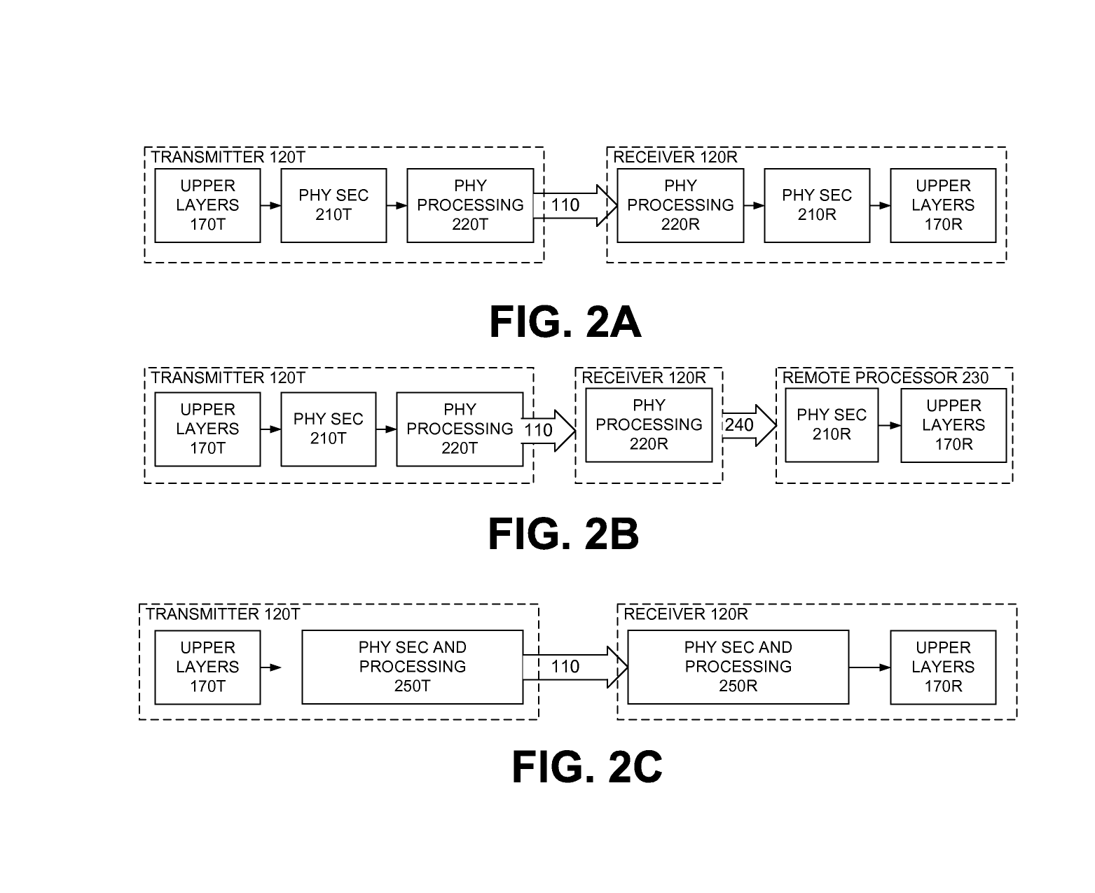

FIGS. 2A-C are block diagrams depicting various ways in which the functionality of secure physical layer 160 can be placed in the data path from transmitter 120T to receiver 120R. Each embodiment includes the same components. Transmitter 120T includes upper layers 170T, followed by physical layer security module 210T, followed by physical layer processing module 220T. Receiver 120R includes analogous components but in the reverse order: physical layer processing module 220R, followed by physical layer security module 210R, followed by upper layers 170R. Transmitter 120T and receiver 120R are coupled via main channel 110.

The embodiments of FIGS. 2A, B, and C differ in the location of, and level of integration of, physical layer security module 210. In FIG. 2A, upper layers 170T, physical layer security module 210T, and physical layer processing module 220T all reside locally in transmitter 120T. Similarly, physical layer processing module 220R, physical layer security module 210R, and upper layers 170R all reside locally in receiver 120R, in the same housing.

In FIG. 2B, components of transmitter 120T are local, but only physical layer processing module 220R resides in receiver 120R. Inverse processing by physical layer security module 21 OR and upper layers 170R is performed remotely at a remote processor 230. Receiver 120R and remote processor 230 are coupled by separate secondary communication channel 240. In this embodiment, remote processor 230 and receiver 120R reside in different housings.

In FIG. 2C, all components of transmitter 120T reside locally, but the transmit functions of physical layer security and physical layer processing are integrated into a combined module 250R, for example, implemented as a single chip. Similarly, all components of receiver 120R reside locally, but the receive functions of physical layer security and physical layer processing are integrated into a combined module 250R.

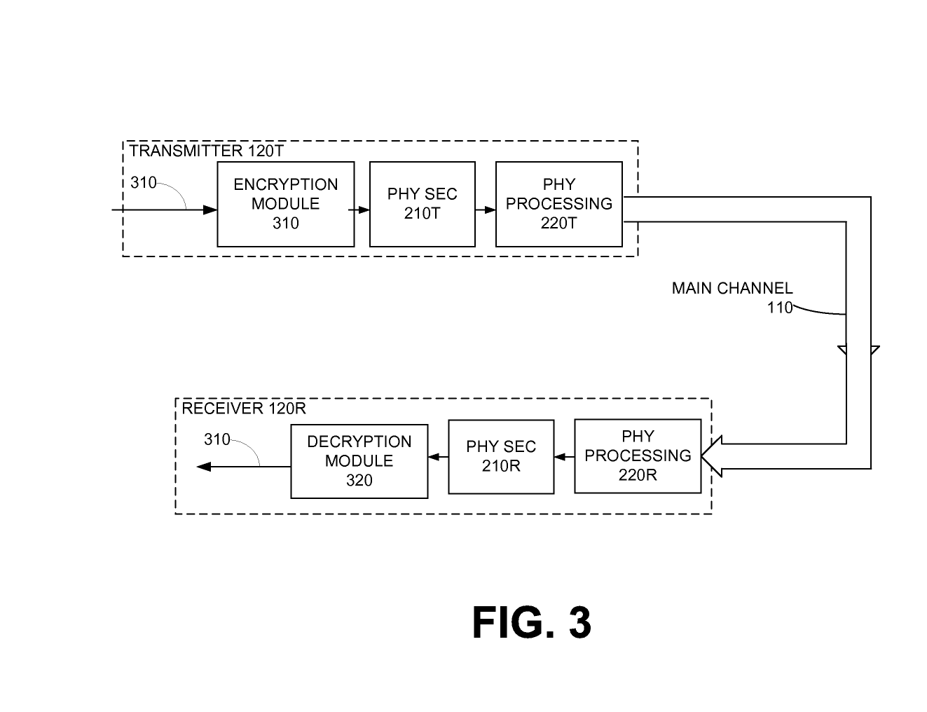

Secure physical layer 160 can also be combined with cryptography to provide an additional level of security. FIG. 3 is a block diagram illustrating physical layer security and cryptography in the data path from transmitter 120T to receiver 120R. In transmitter 120T, user data 310 is processed by an encryption module 320 before being handled by physical layer security module 210T and physical layer processing module 220T. The encrypted and physically secure data is transmitted over main channel 110 to receiver 120R. In receiver 120R, the encrypted and physically secure data is handled by physical layer processing module 220R and physical layer security module 210R, and then decrypted by decryption module 330 to recover user data 310. In some embodiments, encryption module 320 and decryption module 330 are implemented in upper protocol layers 170 (FIG. 1), for example, Transport Layer Security (TLS) or Secure Sockets Layer (SSL).

Various techniques for configuring physical layer security module 210 will now be described. The parameters utilized in physical layer security module 210 to exploit the physical channel characteristics are specified by configuration information. A particular instance of physical layer security module 210 can thus be constructed or initialized based on configuration data. The particular set of parameters specified in the configuration of a physical layer security module 210 varies according to the type of code or transform used. For example, the configuration data for embodiments which utilize an arrangement of rate-1 non-recursive convolutional encoders in series with permuters may specify the number of encoders and permuters, the input-to-output bit mapping used by each permuter, and the shift register depth, number of adders, and tap locations in each encoder. As another example, the configuration data for a secure error correcting encoder may specify a generator matrix. As yet another example, the configuration data for an LPDC encoder may specify a parity matrix. As another example, the configuration data for a convolutional encoder may specify a generator matrix or a transfer function.

In some embodiments, physical layer security configuration data takes the form of a bit vector. However, many other ways of specifying a configuration are contemplated, including (but not limited to) text, a markup language such as eXtensible Markup Language (XML), and serialized XML.

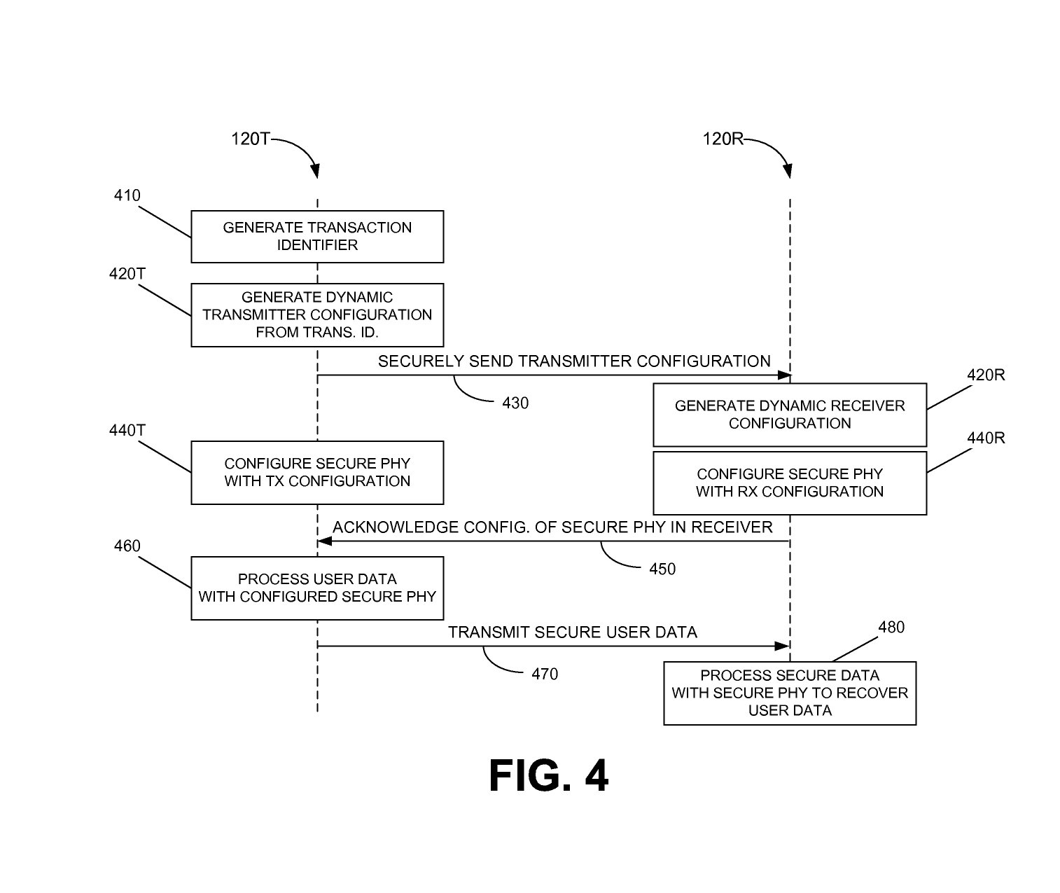

FIG. 4 is a data flow diagram showing one method of configuring secure physical layer 160 in a transmitter 120T and in a corresponding receiver 120R, in communication over main channel 110 (FIG. 1). At block 410, transmitter 120T generates a transaction identifier. The transaction identifier is unique to a data session, and may be pseudo-random. At block 420T, transmitter 120T dynamically generates a transmitter security configuration from the transaction identifier. In some embodiments, transmitter 120T stores a predefined set of transformer configurations, and the transaction identifier is used to randomly select one of them. This may be appropriate if only a relatively small number of transformer configurations lead to the desired characteristic p_{EVE}≈½.

Transmitter 120T then transmits (arrow 430) the transmitter security configuration to receiver 120R in a secure manner. Mechanisms for securely providing the transmitter security configuration to receiver 120R will be discussed in further detail below. After receiving this information about the configuration of physical layer security module 210 in transmitter 120T, receiver 120R uses this information at block 420R to dynamically generate a receiver security configuration that is the inverse or complement of the transmitter security configuration. At block 440, receiver 120R configures physical layer security module 210R with the receiver security configuration. Once provided with this inverse configuration, physical layer security module 210R is able to recover any data secured by physical layer security module 210T.

Asynchronously, at block 440T, transmitter 120T configures physical layer security module 210T with the transmitter security configuration and waits for acknowledgement from receiver 120R before transmitting user data to receiver 120R. At some later point in time, receiver 120R sends an indication (arrow 450), acknowledging that physical layer security module 210R has been configured (at block 440T). Now that both sides of the channel have been configured, transmission can begin.

To this end, at block 460, transmitter 120T processes user data with physical layer security module 210T, and sends (arrow 470) the resulting secured data to receiver 120R. At block 480, receiver 120R processes the received secured data with physical layer security module 210R, thus recovering the user data sent from transmitter 120T.

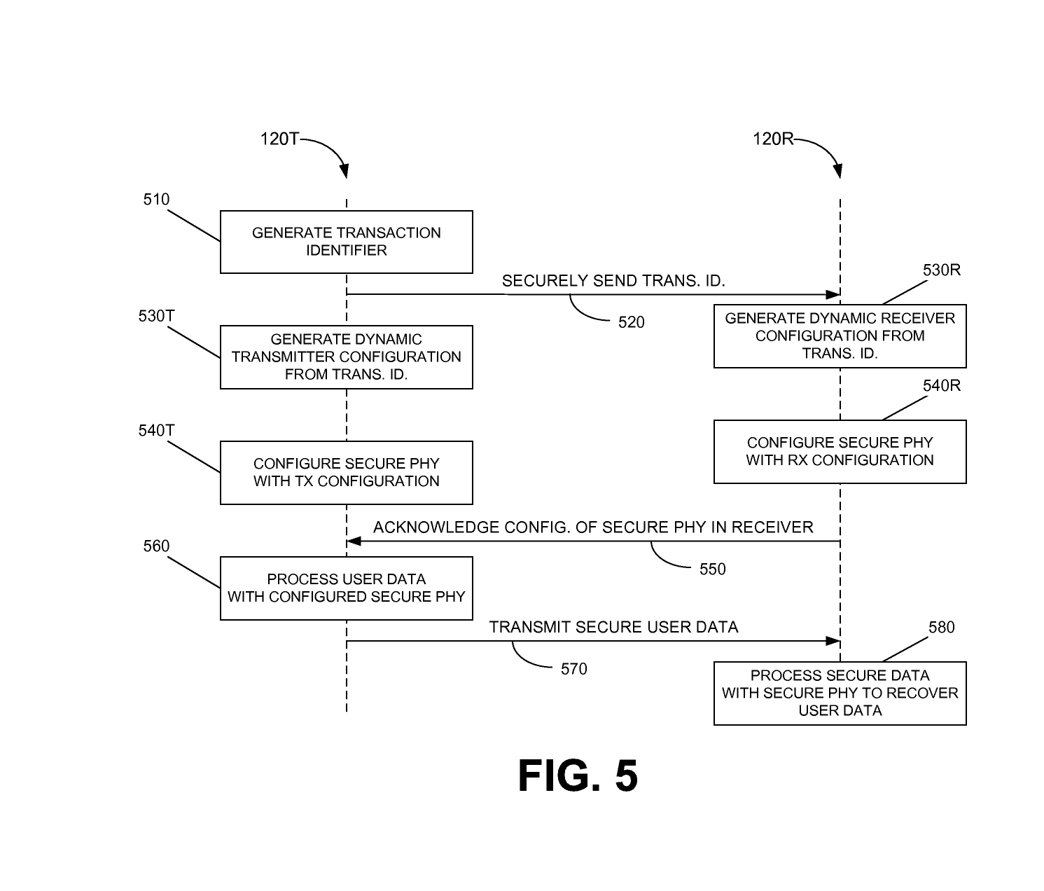

FIG. 5 is a data flow diagram showing another method of configuring secure physical layer 160 in a transmitter 120T and in a corresponding receiver 120R, in communication over main channel 110 (FIG. 1). This method is similar to the method of FIG. 4, but instead of sending a transmitter security configuration to receiver 120R, transmitter 120T sends the transaction identifier instead.

At block 510, transmitter 120T generates a transaction identifier. The transaction identifier is pseudo-random, and may be unique to a data session. Transmitter 120T then transmits (arrow 520) the transaction identifier to receiver 120R in a secure manner. Mechanisms for securely providing the transmitter security configuration to receiver 120R will be discussed in further detail below.

After receiving the dynamically generated transaction identifier, receiver 120R uses this identifier, at block 530R, to dynamically generate a receiver security configuration that is the inverse or complement of the transmitter security configuration. This inverse configuration allows physical layer security module 210T to recover the data transformed by physical layer security module 210R.

Asynchronously, at block 530T, transmitter 120T dynamically generates a transmitter security configuration from the transaction identifier. Generating the transmitter security configuration was discussed above in connection with FIG. 4. At block 540T, transmitter 120T configures physical layer security module 210T with the transmitter security configuration, while at block 540R, receiver 120R configures physical layer security module 210R with the receiver security configuration.

Transmitter 120T waits for acknowledgement from receiver 120R before transmitting user data to receiver 120R. At some later point in time, receiver 120R sends an indication (arrow 550), acknowledging that physical layer security module 210T has been configured (at block 540T). Now that both sides of the channel have been configured, transmission can begin. To this end, at block 560, transmitter 120T processes user data with physical layer security module 210T, and sends (arrow 570) the resulting secured data to receiver 120R. At block 580, receiver 120R processes the received secured data with physical layer security module 210R, thus recovering the user data sent from transmitter 120T.

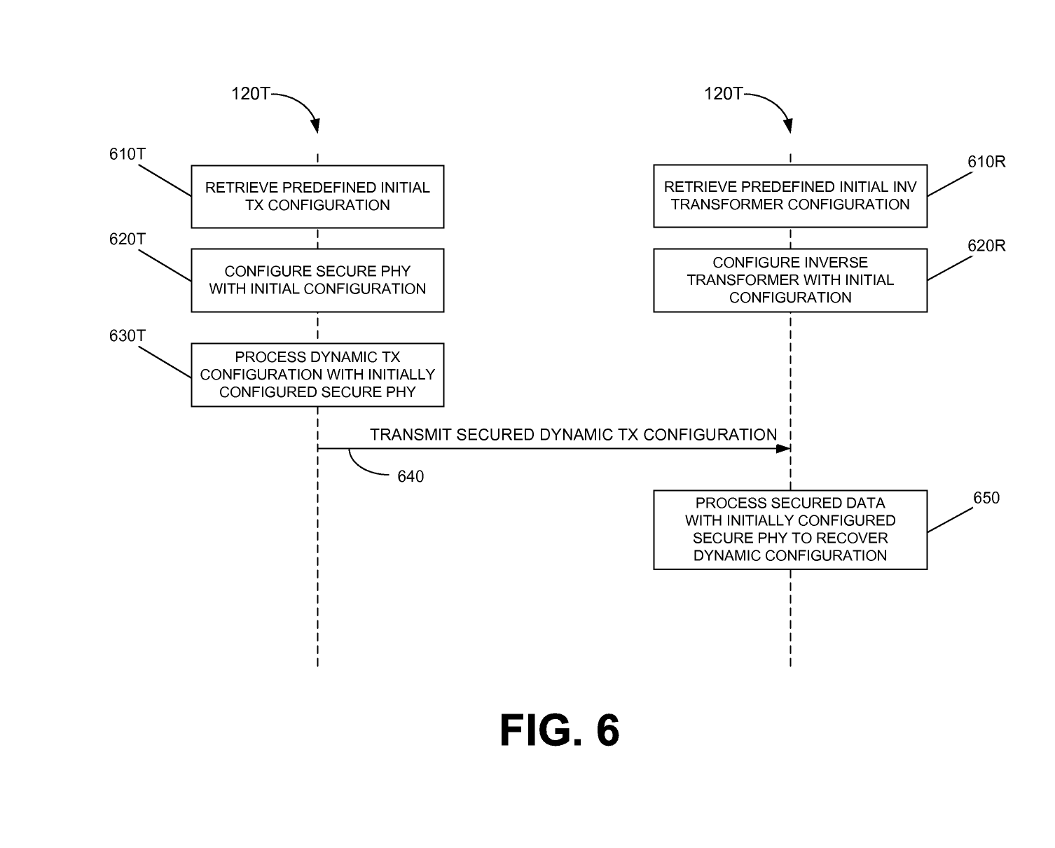

The configuration method discussed above in connection with FIG. 5 uses a secure mechanism to provide receiver 120R with the transaction identifier that is dynamically generated by transmitter 120T. The configuration method discussed above in connection with FIG. 4 also uses a secure mechanism to provide receiver 120R with the transmitter security configuration that is dynamically generated by transmitter 120T. One such secure mechanism involves encrypting the transmitter configuration using a key. Another secure mechanism for securely communicating this information will now be discussed in connection with the data flow diagram of FIG. 6. FIG. 6 can be viewed as a more detailed view of the secure transmission step of FIG. 4 (block 430) or FIG. 5 (block 520), in which transmitter 120T uses a static configuration known a priori to both sides to provide receiver 120R with dynamically generated transmitter security configuration.

At block 610T, transmitter 120T retrieves from storage a predefined (static) initial configuration for the physical layer security module 210T, while at block 610R, receiver 120R retrieves from storage a corresponding predefined initial configuration for the physical layer security module 210R. At block 620T, transmitter 120T configures physical layer security module 210T with this initial configuration, while at block 620R, receiver 120R configures physical layer security module 210R with a corresponding (inverse) initial configuration.

Once physical layer security module 210 and physical layer security module 210 have been constructed in accordance with their corresponding initial configurations, transmitter 120T and receiver 120R can exchange data in a manner that is protected from eavesdropper 130. To this end, at block 630T, transmitter 120T processes the dynamic transmitter security configuration using the statically configured (at block 620T) physical layer security module 210T, and transmits (arrow 640) the secured configuration information to receiver 120R. This transmission may use lower power as comparing to transmitting user data.

At block 630R, receiver 120R processes the received data with the statically configured (at block 620T) physical layer security module 210R, thus recovering the transmitter security configuration that was dynamically generated by transmitter 120T (at block 420T of FIG. 4). Having completed secure transmission of the dynamically generated transmitter security configuration, processing then continues at block 420R of FIG. 4 or block 530R of FIG. 5.

Having discussed in detail two methods of configuring secure physical layer 160 using secure transmission of configuration information, a third method will now be discussed that relies on user action, rather than a secure transmission channel, to convey configuration information.

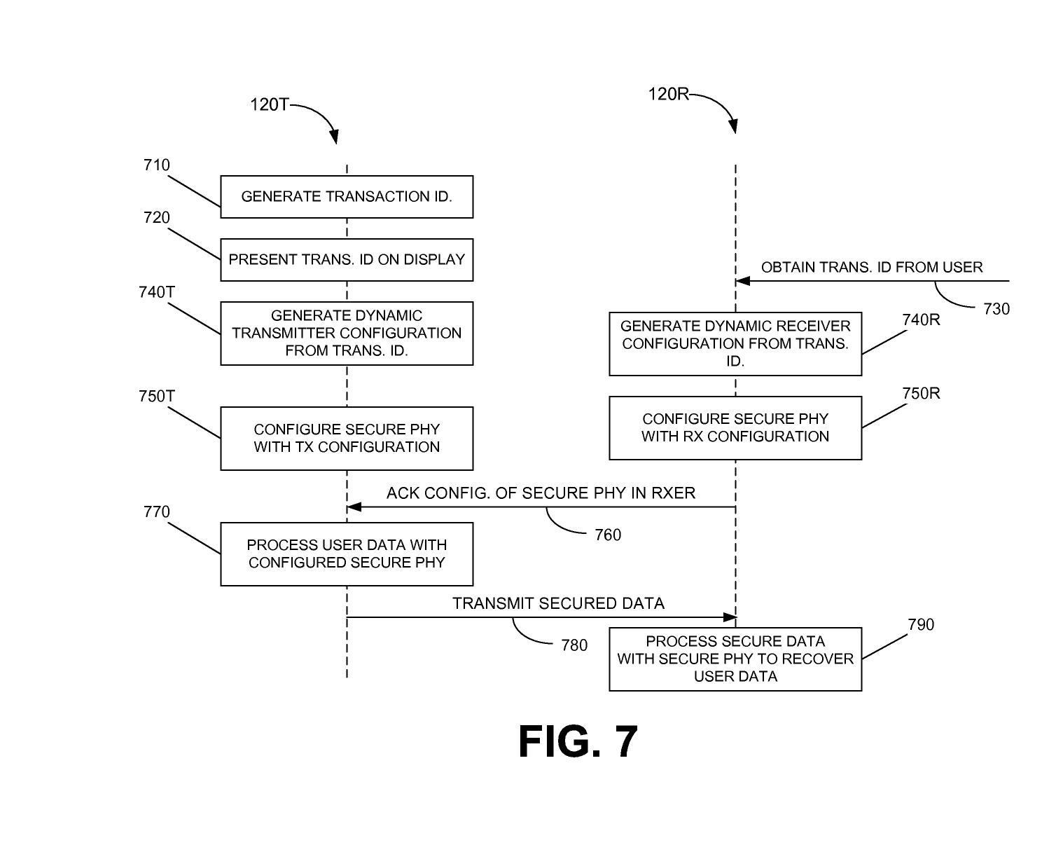

FIG. 7 is a data flow diagram of the third method of configuring secure physical layer 160 in a transmitter 120T and in a corresponding receiver 120R, in communication over main channel 110 (FIG. 1). In this embodiment, transmitter 120T includes a display and receiver 120R includes at least one user interface device such as a keyboard, mouse, touch screen, etc. At block 710, transmitter 120T generates a transaction identifier, as described earlier. Next, at block 720, transmitter 120T presents the transaction identifier on its display, where it is visible to a user. At step 730, receiver 120R obtains the displayed identifier from the user through its user interface. As a result, both sides of the communication system have the same transaction identifier.

The process then continues in a manner analogous to that discussed earlier in connection with FIGS. 4 and 5. At block 740T, transmitter 120T dynamically generates a transmitter security configuration from the transaction identifier, using techniques disclosed herein. Next, at block 740R, receiver 120R uses the transaction identifier to dynamically generate receiver security configuration that is the inverse or complement of transmitter security configuration, using techniques disclosed herein. At block 750T, transmitter 120T configures physical layer security module 210T with transmitter security configuration and waits for acknowledgement from receiver 120R before transmitting user data to receiver 120R. At 750R, receiver 120R configures physical layer security module 210R with receiver security configuration.

At some later point in time, receiver 120R sends an indication (arrow 760), acknowledging that physical layer security module 210R has been configured. Now that both sides of the channel have been configured, transmission can begin. To this end, at block 770, transmitter 120T processes user data with physical layer security module 210T, and sends (arrow 780) the resulting transformed data to receiver 120R. At block 790, receiver 120R processes the received transformed data with physical layer security module 210R, thus recovering the user data sent from transmitter 120T.

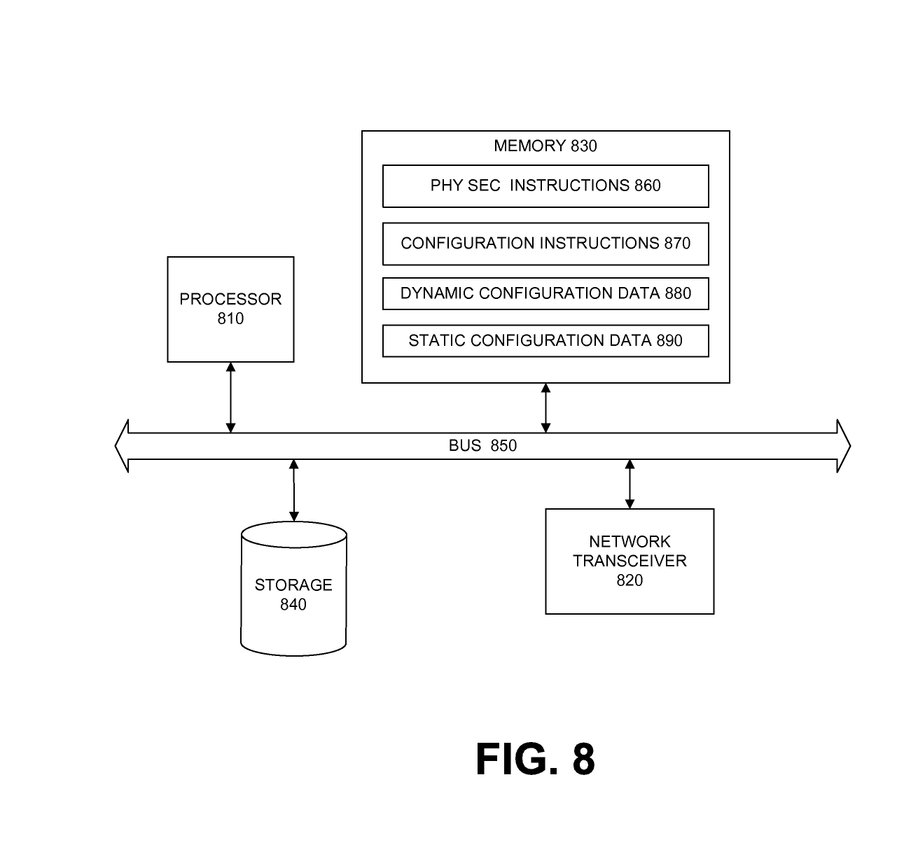

FIG. 8 is a hardware block diagram of an embodiment of communication device 120 in which physical layer security module 210 and physical layer security module 210 are implemented in software or firmware, that is, as instructions stored in a memory and executed by a suitable microprocessor, digital signal processor, network processor, microcontroller, etc. Communication device 120 contains a number of components that are well known in the art of data communications, including a processor 810, a network transceiver 820, memory 830, and non-volatile storage 840. These components are coupled via a bus 850. Network transceiver 820 may support one or more of a variety of different networks using various technologies, media, speeds, etc. A non-limiting list of examples of wireless technologies includes: radio frequency identification (RFID) networks (e.g., ISO 14443, ISO 18000-6); near field communications (NFC) networks; wireless local area networks (e.g. IEEE 802.11, commonly known as WiFi); wireless wide area networks (e.g., IEEE 802.16, commonly known as WiMAX); wireless personal area networks (e.g., Bluetooth™, IEEE 802.15.4) and wireless telephone networks (e.g., CDMA, GSM, GPRS, EDGE).

Examples of non-volatile storage include, for example, a hard disk, flash RAM, flash ROM, EPROM, etc. Memory 830 contains physical layer security instructions 860 that program or enable processor 810 to implement the functions of physical layer security module 210. Memory 830 also contains configuration instructions 870 that program or enable processor 810 to construct or initialize physical layer security module 210, using dynamic configuration information 880 or static configuration information 890. Omitted from FIG. 8 are a number of conventional components, known to those skilled in the art that are not necessary to explain the operation of communication device 120. The embodiment of FIG. 8 may also contain software to implement functions such as management, initialization of hardware, protocol stack layers, etc.

Some embodiments of physical layer security module 210 and/or physical layer security module 210 are stored on a computer-readable medium, which in the context of this disclosure refers to any structure which can contain, store, or embody instructions executable by a processor. The computer readable medium can be, for example but not limited to, based on electronic, magnetic, optical, electromagnetic, infrared, or semiconductor technology. Specific examples of a computer-readable medium using electronic technology would include (but are not limited to) the following: a random access memory (RAM); a read-only memory (ROM); and an erasable programmable read-only memory (EPROM or Flash memory). A specific example using magnetic technology includes (but is not limited to) a disk drive; and a portable computer diskette. Specific examples using optical technology include (but are not limited to) a compact disk read-only memory (CD-ROM) or a digital video disk read-only memory (DVD-ROM).

Other embodiments of physical layer security module 210 and/or physical layer security module 210 (not illustrated) are implemented in hardware logic, as security transformer logic and inverse security transformer logic. Technologies used to implement security transformer logic and inverse security transformer logic in specialized hardware may include, but are not limited to, a programmable logic device (PLD), a programmable gate array (PGA), field programmable gate array (FPGA), an application-specific integrated circuit (ASIC), a system on chip (SoC), and a system on packet (SoP). In yet another embodiment of communication device 120 (not illustrated), physical layer security module 210 and/or physical layer security module 210 are implemented by a combination of software (i.e., instructions executed on a processor) and hardware logic.

Any process descriptions or blocks in flowcharts would be understood as representing modules, segments, or portions of code which include one or more executable instructions for implementing specific functions or steps in the process. As would be understood by those of ordinary skill in the art of the software development, alternate implementations are also included within the scope of the disclosure. In these alternate implementations, functions may be executed out of order from that shown or discussed, including substantially concurrently or in reverse order, depending on the functionality involved.

The foregoing description has been presented for purposes of illustration and description. It is not intended to be exhaustive or to limit the disclosure to the precise forms disclosed. Obvious modifications or variations are possible in light of the above teachings. The implementations discussed, however, were chosen and described to illustrate the principles of the disclosure and its practical application to thereby enable one of ordinary skill in the art to utilize the disclosure in various implementations and with various modifications as are suited to the particular use contemplated. All such modifications and variation are within the scope of the disclosure as determined by the appended claims when interpreted in accordance with the breadth to which they are fairly and legally entitled.

What is claimed is:

1. A communication device used on a communication channel, the device comprising:
a physical layer security module residing in a physical layer of the device and operable to transform user data in accordance with one or more security characteristics; and
a physical layer processing module residing in the physical layer and operable to process the transformed data into a format suitable for the communication channel and further operable to transmit the processed data onto the communication channel,
wherein the one or more security characteristics of the physical layer security module are such that decoding the intercepted user data by the eavesdropper results in a bit error rate of about one-half.

2. The device of claim 1, wherein the physical layer processing module is further operable to process the transformed data into a format suitable for the communication channel by performing error correction coding on the transformed data.

3. The device of claim 1, wherein the physical layer security module is further operable to transform the user data by encoding the user data with a secure error correction code.

4. The device of claim 1, wherein further comprising an encryption module operable to encrypt the user data before providing the encrypted user data to the physical layer security module.

5. The device of claim 1, wherein the physical layer security module resides on a first chip and the physical layer processing module resides on a separate second chip.

6. The device of claim 1, wherein the physical layer security module is integrated on a single chip with the physical layer processing module.

7. The device of claim 1, wherein the physical layer security module is located remotely from the physical layer processing module and communicates with the physical layer processing module over a secondary communication channel.

8. A system comprising:
a transmitter device including a transmitter physical layer security module; and
a receiver device including a receiver physical layer security module,
the transmitter device being operable to:
generate a transmitter security configuration;
transmit the transmitter security configuration to the receiver device;
configure the transmitter physical layer security module in accordance with the transmitter security configuration;
process user data with the transmitter physical layer security module to produce secured data; and
transmit the secured data to the receiver device,
the receiver device being operable to:
receive the transmitter security configuration from the transmitter device;
generate receiver configuration data from the received transmitter security configuration;
configure a receiver physical layer security module in accordance with the receiver configuration data; and
process data received from the transmitter device with the receiver physical layer security module to recover the user data,
wherein the transmitter security configuration specifies a configuration of the transmitter physical layer security module such that decoding the secured data as received by an eavesdropper results in a bit error rate of about one-half.

9. The system of claim 8, wherein the transmitter physical layer security module comprises a secure error code encoder and the transmitter security configuration specifies a generator matrix.

10. The system of claim 8, wherein the transmitter physical layer security module comprises a convolutional encoder and the transmitter security configuration specifies a transfer function, a generator matrix, or a combination thereof.

11. The system of claim 8, wherein the transmitter physical layer security module comprises a series of rate-1 recursive convolutional encoders interspersed with one or more bit-level permuters and the transmitter security configuration specifies any combination of a shift register depth, a tap configuration, an adder configuration, and a bit-level permuter configuration.

12. A system comprising:
a physical layer security transmitter device including a display; and
a physical layer security receiver device including a user input device,
the transmitter device being operable to:
generate a transaction identifier;
generate transmitter security configuration from the transaction identifier;
present the transaction identifier on the display;
configure a transmitter physical layer security module in accordance with the transmitter security configuration;
process user data with the transmitter physical layer security module to produce secured data; and
transmit the transformed data to the receiver device,
the receiver device being operable to:
obtain, through the user input device, the transaction identifier;
generate inverse transformer configuration data from the obtained transaction identifier;
configure a receiver physical layer security module in accordance with the transmitter security configuration; and
process data received from the transmitter device with the receiver physical layer security module to recover the user data,
wherein the transmitter security configuration specifies a configuration of the transmitter physical layer security module such that decoding the transformed data as received by an eavesdropper results in a bit error rate of about one-half.

13. The system of claim 12, wherein the transmitter physical layer security module comprises a pre-processor and a secure error code encoder.

14. The system of claim 12, wherein the transmitter physical layer security module comprises a secure error code encoder and the transmitter security configuration specifies a generator matrix.

15. The system of claim 12, wherein the transmitter physical layer security module comprises a low density parity code (LPDC) coder and the transmitter security configuration specifies a parity matrix.

16. The system of claim 12, wherein the transmitter physical layer security module comprises a series of rate-1 recursive convolutional encoders interspersed with one or more bit-level permuters and the transmitter security configuration specifies any combination of a shift register depth, a tap configuration, an adder configuration, and a bit-level permuter configuration.

17. The system of claim 12, wherein the transmitter security configuration is expressed as a bit vector.

18. A method of securing user data during transmission, the method comprising:
generating, by a transmitter device, a transaction identifier;
generating, by the transmitter device, a transmitter security configuration from the transaction identifier;
securely transmitting, by the transmitter device to a receiver device, the transaction identifier or the transmitter security configuration;
configuring, by the transmitter device, a physical layer security module in accordance with the transmitter security configuration;
processing, by the transmitter device, user data with the configured transmitter physical layer security module to produce secured data; and
transmitting, by the transmitter device to the receiver device, the secured data,
wherein the transmitter security configuration specifies a configuration of the transmitter physical layer security module such that decoding the secured data as intercepted by an eavesdropper results in a bit error rate of about one-half.

19. The method of claim 18, wherein the securely transmitting comprises:
encrypting the transaction identifier or the transmitter security configuration; and
transmitting, by the transmitter device to a receiver device, the encrypted transaction identifier or the encrypted transmitter security configuration.

20. The method of claim 18, wherein the securely transmitting comprises:
initially configuring, at the transmitter device, the transmitter physical layer security module in accordance with predefined transmitter security configuration;
processing, by the transmitter device, the transmitter security configuration with the initially configured transmitter physical layer security module to produce initial secured data; and
transmitting, by the transmitter device to the receiver device, the initial secured data,
wherein the transmitter security configuration specifies another configuration of the transmitter physical layer security module such that decoding the initial secured data as intercepted by the eavesdropper results in another bit error rate of about one-half.

21. The method of claim 20, wherein the securely transmitting is performed before the configuring.

22. The method of claim 20, wherein the securely transmitting is performed using at a lower power than used by the transmitting of the secured data.

23. The method of claim 20, wherein the predefined transmitter security configuration is different than the transmitter security configuration.
